(19) United States
(12) Patent Application Publication
(10) Pub. No.: US 2004/0237406 A1
(43) Pub. Date: Dec. 2, 2004

(54) Membrane reactor and method for the production of highly pure hydrogen gas

(76) Inventor: Franz Fuder, Bottrop (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,415

(22) PCT Filed: Aug. 17, 2001
(86) PCT No.: PCT/EP01/09528

(30) Foreign Application Priority Data
Aug. 18, 2000 (DE) 100 40 539.8
Apr. 11, 2001 (DE) 101 18 248.1

(51) Int. Cl. B01J 8/00

(52) U.S. Cl. 48/198.2; 48/127.9

(57) ABSTRACT

The subject matter of the invention is a membrane reactor for the generation of high-purity hydrogen from a hydrocarbon stream and steam comprising a hydrogen-permeable diffusion membrane and possibly a catalyst for converting hydrocarbons into hydrogen and for separating the hydrogen gas from the residual gas, with the membrane and possibly the reactor being fitted with heating elements. A further subject matter of the invention is a process to generate high-purity hydrogen gas using a pre-treatment step.

The subject matter of the invention is a membrane reactor for the generation of high-purity hydrogen from a hydrocarbon stream and steam as well as a process for the generation of high-purity hydrogen and of a suitable hydrocarbon mixture, which serves as the fuel. The reactor is supposed to be preferably used in fuel cell-powered vehicles and domestic heating systems.

The terms used in this description are defined below. “Waste gas” is the gas generated in the post-combustion of the retentate. It consists of water and carbon dioxide. The term “reformate” describes the product, which is generated in the steam reforming reaction. By means of the membrane, the reformate is separated into permeate and retentate. The reformate consists of hydrogen, water, carbon monoxide and carbon dioxide. The term “permeate” designates the gas which permeates the membrane. It is hydrogen. The gas which leaves the reformer is called “retentate”. It consists of carbon dioxide, residual hydrocarbons, hydrogen, water and carbon monoxide.

On a technical scale hydrogen is generated from hydrocarbons. The hydrocarbon sources can be liquefied petroleum gas, liquid motor fuels such as petrol, diesel or methanol. As a rule the process is carried out in two steps. Initially hydrocarbons and water are converted into hydrocarbon gas and carbon monoxide in an endothermal reaction. This step is also known as the steam reforming process. Reaction takes place at temperatures above 600° C. In a further reaction step, the so-called shift reaction, the carbon monoxide generated in the reforming reaction is converted with water into hydrogen gas and carbon dioxide. This reaction occurs at temperatures below 350° C. The shift reaction is an exothermal reaction.

The disadvantages of this state-of-the-art process are that the energy efficiency rate of the system is smaller 75%, that the hydrogen generated needs to be cleaned and concentrated after the reforming reaction in order to remove the carbon monoxide that has also been generated or subject it to the shift reaction.

For those reasons reactors have recently been developed for the generation of hydrogen which contain membranes that serve to increase the purity rate of the hydrogen generated.

WO 99/43610 A 1, for example, describes how a membrane reactor is used to generate hydrogen by directly converting hydrocarbons. This process generates high-purity hydrogen by converting a hydrocarbon stream in a membrane reactor fitted with a nickel-containing catalyst. The membrane reactor contains a hydrogen-permeable membrane and a catalyst able to generate hydrogen directly from hydrocarbons through cracking. The hydrocarbon stream is brought into contact with the catalyst at temperatures between 400 and 900° C. so that the conversion of the gas takes place, forming hydrogen. Subsequently the hydrogen selectively permeates the membrane wall and leaves the reactor.

In a similar way WO 99/25649 A 1 describes a membrane reactor for the generation of hydrogen. This reactor is fitted with a catalyst bed as well as a hydrogen diffusion membrane through which the hydrogen can selectively be separated from the other compounds of the waste gas stream. The hydrogen diffusion membrane preferably consists of a palladium-based spiral or a spiral-shaped tube or a tube bundle. Alternatively it is also possible to use a palladium alloy on a porous ceramic substrate. The catalyst bed normally consists of a granular bed of catalyst particles or a porous ceramic carrier material coated with the catalyst. The catalyst bed and the hydrogen diffusion membrane are preferably located in the same reactor vessel and the catalyst bed is preferably concentrically and coaxially arranged around the hydrogen diffusion membrane.

Further membrane reactors for the generation of hydrogen from hydrogen-containing precursors are known from the German patent applications DE 199 20 517 C1, DE 198 04 286 A1, DE 197 57 506 A1 and DE 197 55 813 A1. These documents also describe a process for the generation of hydrogen by means of reforming and its subsequent separation through a membrane (permeation). The first two of the documents listed furthermore mention that the membrane is additionally heated.

Conventional reaction control in membrane reactors requires the supply of process heat into the reactor in order to carry out the endothermal reaction. The necessary process heat is usually generated by burning part of the hydrogen fed into the reactor with air. Temperatures above 600° C. must be reached to carry out the steam reforming reaction. The partial burning of the hydrogen, however, has the disadvantage that oxygen or air need to be supplied for the combustion process which is turn leads to a dilution of the hydrogen generated through the nitrogen contained in the air. Further dilution occurs through the carbon dioxide generated in the combustion process.

Furthermore this process is thermodynamically unfavourable as external firing or the combustion of hydrocarbons are always needed to generate the process heat required for the steam reforming reaction.

The technical problem of the invention therefore is to make a membrane reactor available in which the required process heat is generated in the reactor without burning part of the hydrocarbons and which generates hydrogen of the highest possible purity without any contaminants.

This technical problem is solved by a membrane reactor for the generation of high-purity hydrogen from a hydrocarbon stream and steam according to claim 1. Preferably the membrane material acts as a catalyst.

The heating elements can be an electric heating or also a combustion heating system fired with hydrogen, carbon monoxide, and/or hydrocarbons. The heating elements are heating conductors located in the centre of the reactor. Preferably these heating conductors are of tubular shape which allows the post-combustion of the residual gas. Thus it is possible to generate the necessary process heat for the steam reforming reaction where it is needed, i.e. at the catalyst, which is preferably located inside the membrane. It is basically possible to place the heating elements in several ways in the reactor. It would, for instance, be possible to generate the entire amount of heat in the membrane so that an easily-controllable reactor would be available. In this case, however, a thicker membrane would have to be used in order to generate the required heat. As a rule the membrane thickness ranges from 1 to 2000 μm, it preferably is between 10-30 μm, a particularly preferable thickness is 20 μm.

A further embodiment describes that the heat is partially generated by the membrane and partially by a heating conductor in the centre of the reactor. In this case the membrane would only have to be approximately 10 μm thick. It is desirable to use as thin a membrane as possible for two reasons. On the one hand hydrogen permeation increases significantly as the permeation rate is inversely proportional to the thickness of the membrane, i.e. reducing the membrane thickness by 50% doubles the hydrogen permeation rate of the membrane. On the other hand membrane costs can be significantly lowered as the membrane area can be halved to achieve the same hydrogen permeation. This is a major factor for the economic efficiency of this process as palladium, e.g., a potential membrane material, currently costs approximately DM 60.00 per gram.

Furthermore it is chemically favourable if the temperature in the reactor decreases from the centre to the outer edge. The hydrogen concentration decreases with rising temperatures in favour of an increased quantity of carbon monoxide. The permeation rate through the membrane increases with a higher hydrogen concentration. A temperature gradient towards lower temperatures therefore leads to an increase in the hydrogen concentration. The high temperature in the centre of the reactor allows the conversion of the hydrocarbons to carbon monoxide using water.

A centrally located heating conductor furthermore makes it possible to choose a more favourable reactor design in as far as the membrane can be placed at the reactor wall or actually form the wall. Thus a larger uniform membrane area becomes available. In order to achieve similar membrane areas in reactors featuring external heating, a lot of membrane tubes (conventional design) or folded membranes would have to be used in the reactor. Even for purely mechanical reasons such designs are less favourable. Reactors featuring an arrangement according to the invention can also be assembled more simply to so-called stacked reactors (stacked design).

Moreover the heating conductor can also be designed in a tubular shape so that the residual gas from the reformer and the non-converted hydrocarbons can be post-combusted in the tube in order to use the residual energy of the residual gas. The residual gas normally contains further amounts of hydrogen, as the hydrogen is never completely separated by the membrane as well as carbon monoxide, which can also be burned.

In a further preferred embodiment the catalyst is located inside or on the diffusion membrane of the membrane reactor. State-of-the-art designs normally separate the catalyst and the reactor. The reactor dimensions can vary significantly. The reactor diameter can be small, ranging from 1 to 50 mm, preferably 5 mm. The reactor length is between 10 and 2500 cm, preferaby 50 cm.

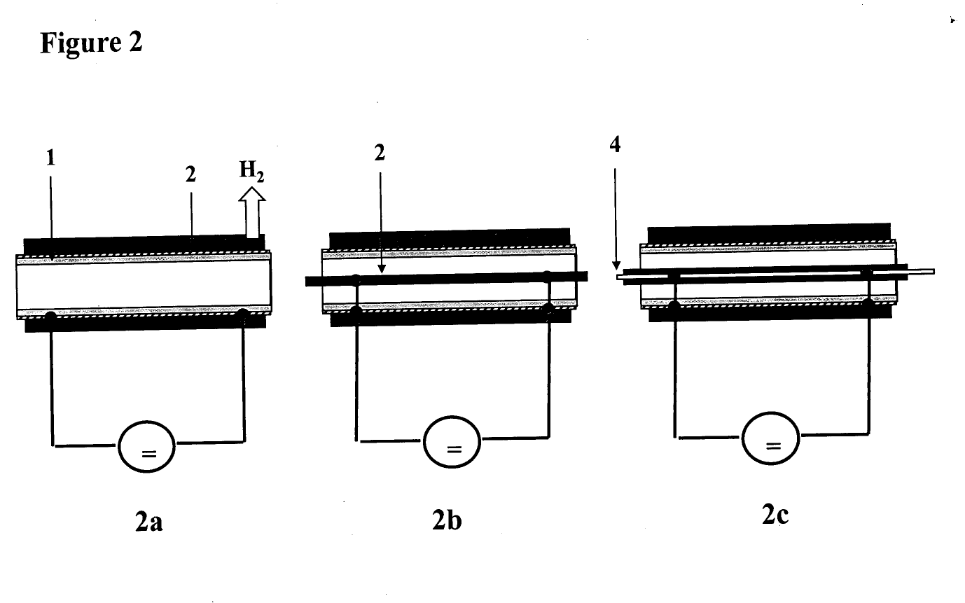

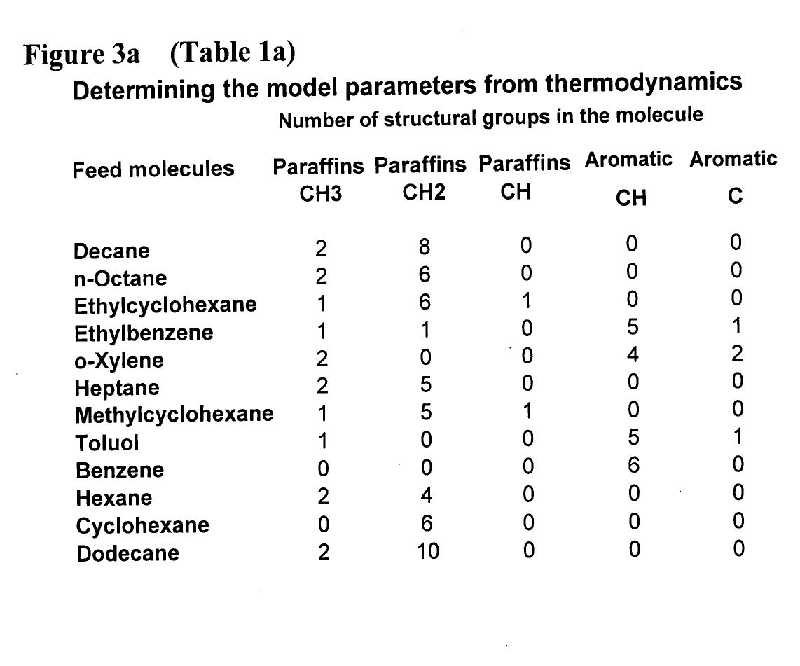

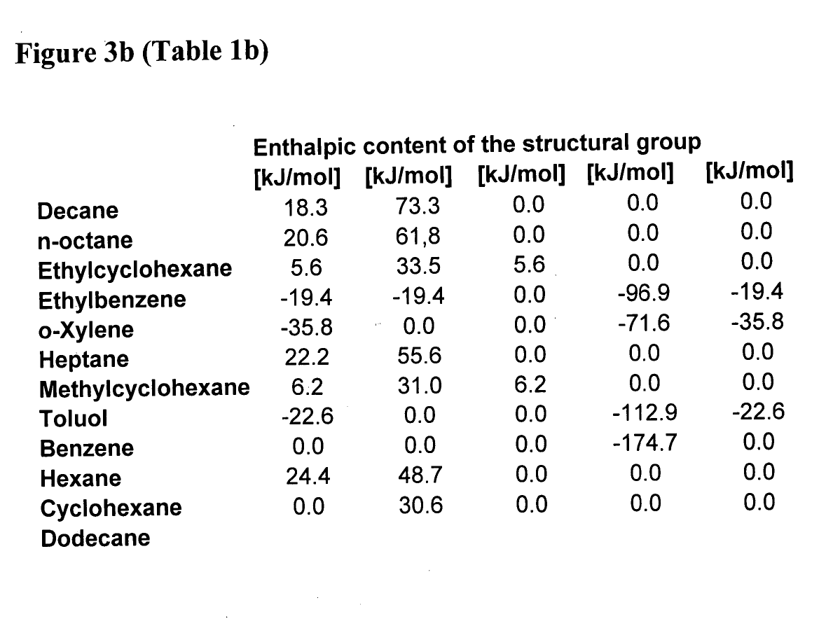

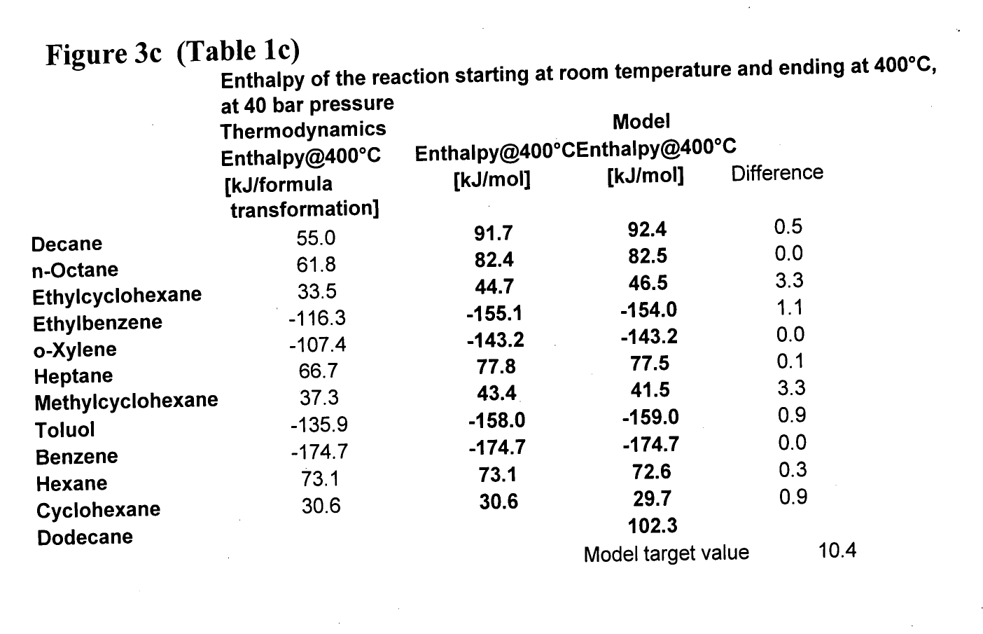

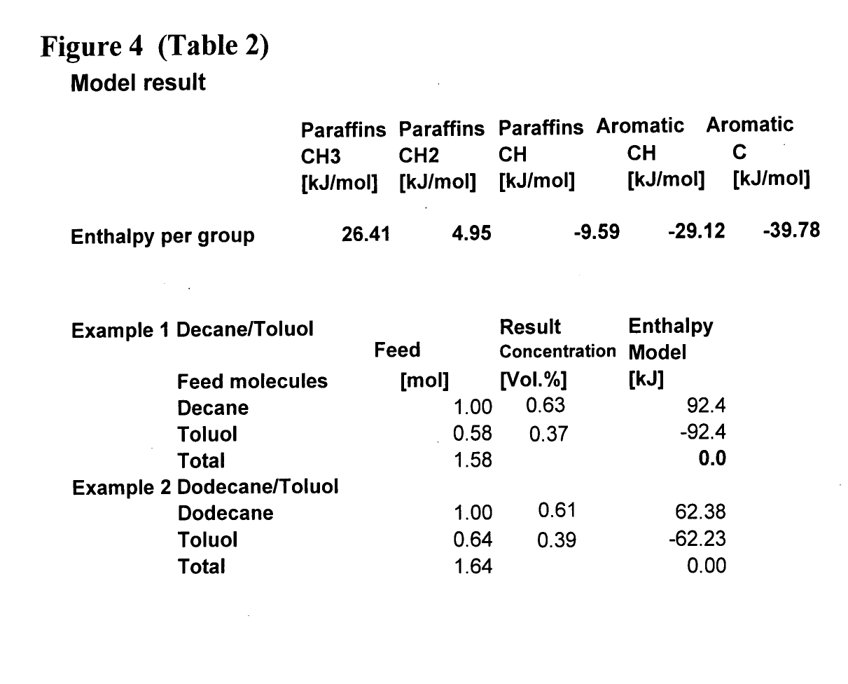

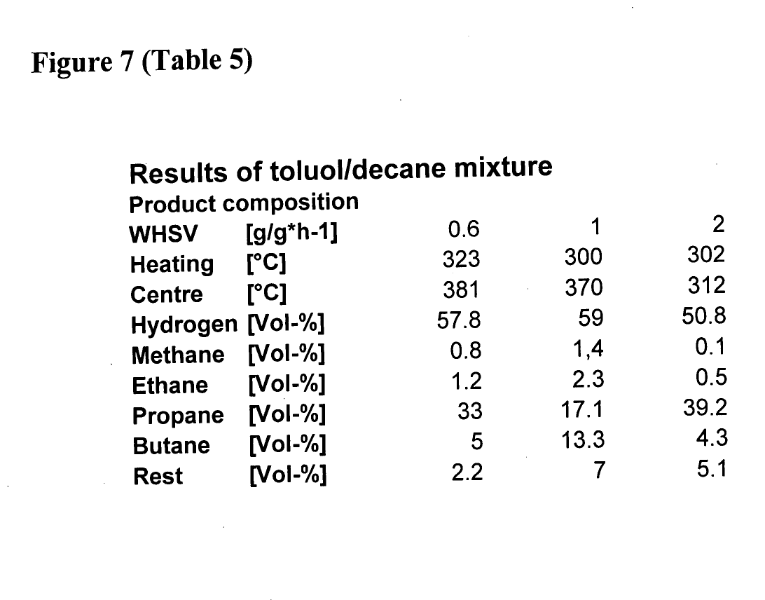

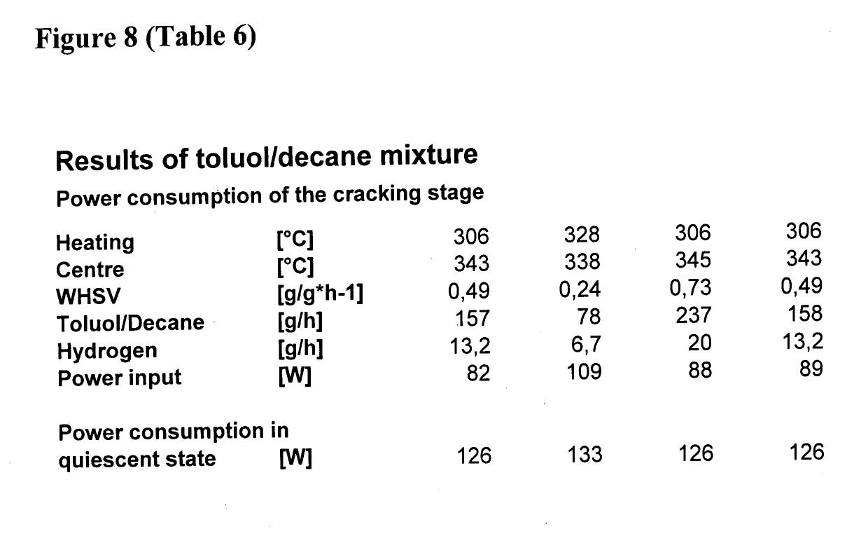

A precious metal alloy is used as the membrane material, preferably a palladium-silver alloy that can also serve as a catalyst. Additionally other metals such as rhodium, ruthenium, nickel, cobalt and iron can also be deposited. The material is deposited onto the membrane using standard procedures, such as soaking, impregnating, dust coating and CVD (chemical vapour deposition). These methods can deposit catalysts onto the membrane. The heating conductor as shown in FIGS. 2b and 2c, can also be catalytically coated, just in the same way as the membrane itself. The membrane is electroconductive and hydrogen-permeable.

In a preferred embodiment the membrane is electroconductive or covered with an electroconductive coating for which metals are used. It is also a preferred embodiment for the diffusion membrane to be concentrically and coaxially arranged around the reaction space and to form the reactor wall through which the hydrogen generated can diffuse.

The reaction itself is a bimolecular reaction. Water and hydrocarbons must be reacted together. For the most part this yields two reaction products, namely carbon monoxide which further reacts with water and converts to carbon dioxide and hydrogen, which needs to diffuse through the membrane.

Hydrogen as well as carbon monoxide adsorp better on the catalyst than hydrocarbons. Due to the endothermal reaction enthalpy the catalyst cools down during the reaction and the cooling process prevents the desorption of the reaction products.

At both these points the electric heating system intervenes. The reaction heat is directly supplied to the active centres. The temperature remains on a high level and this facilitates the desorption of the reaction products. The catalyst remains active.

A further subject matter of the invention is a process for the generation of high-purity hydrogen gas from a hydrocarbon stream and steam using the steam reforming process including a hydrogenating pre-treatment step.

One of the great problems in reforming motor fuels/fuels which normally consist of hydrocarbon mixtures, lies in their mixing with water and in making contact with the heterogenous catalyst. At the temperature levels required for the reforming step fuels show a coking tendency. The systems which heat the hydrocarbons to the required temperature are greatly at risk due to the liquid fuel's tendency to coke, e.g. through nozzle coking or deposits in the evaporators. It is the aim to produce gaseous hydrocarbons, n-paraffins in particular, from liquid hydrocarbons by means of a pre-treatment step. n-Paraffins have the highest reforming activity as regards the target product hydrogen. The respective activity levels of cylcoparaffins and methane are significantly worse. Cycloparaffins cause most of the coking as their molecules can easily react to aromatic compounds by way of dehydration and then further to coke deposits. Avoiding the presence of such unfavourable hydrocarbons has the effect that the reforming temperature can be lowered.

The composition of the hydrocarbon mixture—before it runs through the pre-treatment step—should preferably be such that the heat of hydrogenation is sufficient for the subsequent process steps:

1. Heating the hydrocarbon mixture to the start reaction temperature for the pre-treatment step, preferably >150° C.

2. Heating the hydrocarbon stream, containing the n-paraffins formed, to the entrance temperature for the membrane reactor, preferably >400° C.

3. Superheating the process steam to the entrance temperature for the membrane reactor, preferably >400° C. (optional)

4. Compensating the heat losses

As a rule, hydrocracking reactions such as the one used in the pre-treatment step are exothermal reactions. The heat released increases considerably in the following order: alkane, olefin, and aromatic compounds. The optimum reaction temperature for the pre-treatment step is that temperature which allows maximum yield of n-paraffins and only produces a minimum of methane. The formation of methane requires large quantities of hydrogen which leads to an increase in the hydrogen recycle gas quantity in the overall system. The hydrogen recycle gas quantity required should, however, be as small as possible as the recycling of the hydrogen causes losses and additional separation efforts in the membrane. Moreover methane is unfavourable for the reforming step as it requires a higher reforming temperature due to the high activation energy level.

The problem of this part of the invention is to use a hydrocarbon mixture in the pre-treatment step which for the most part can be converted to n-paraffins on the catalyst when hydrogen is added. The reaction heat level which is generated by the hydrogenation process should be such that the pre-treatment step is carried out in adiabatic conditions and that the outgoing product stream reaches a specified target temperature.

This problem has been solved by the process according to claim 10.

The two processing steps steam reforming and hydrogen separation should preferably not take place in separate locations but be carried out in only one reactor. Especially preferred is an embodiment in which the gas stream within the reactor does not first run through the catalyst, e.g. in the form of a layer of granules, and then reaches the membrane but in which the catalyst is located directly on or inside the membrane.

Especially preferred is a process comprising the following steps:

a) Heating the reactor's diffusion membrane to temperatures of 500-1000° C., preferably 700-900° C., a particularly preferable temperature is 800° C.

b) Feeding the reactant stream into the reactor and converting it on the diffusion membrane, which is preferably fitted with a catalyst, at temperatures of between 500 and 1000° C., preferably 700-900° C., a particularly preferable temperature is 800° C.

c) Removing the hydrogen generated from the reactor through the diffusion membrane

d) Removing the residual gas stream through the reactor.

By heating the reactor's diffusion membrane, the necessary process heat for the endothermal steam reforming process is directly generated at the catalyst in this process; thus the conventional processes for the generation of process heat, such as partial combustion of hydrocarbons, are no longer required to the full extent.

The process according to the invention has the advantage that hydrogen with a high purity level of between 96% and 100% can be generated. This type of hydrogen quality is especially required for use in fuel cells. Furthermore hydrogen generated in this way does not contain any catalyst poisons such as hydrogen sulphide or carbon monoxide which should preferably not be present in a hydrogen stream, especially so if it is to be used in fuel cells for motor vehicles.

Among other things, the hydrocarbon stream is subjected to hydrogenating pre-treatment in order to remove aromatic compounds from the hydrocarbon stream. Hydrocarbons used in commercially available motor fuels normally contain a not inconsiderable quantity of aromatic compounds. These aromatic compounds, however, significantly impair the steam reforming process as they do not convert to hydrogen easily and show a tendency to coke.

The pre-treatment step also serves to generate n-paraffins, preferably methane, ethane, propane and/or butane. Furthermore the pre-treatment step generates heat, which can be used to evaporate the process water needed in the steam reforming process. By specifying a certain concentration level for the aromatic compounds in the hydrocarbon stream, the reactor supplies the heat required for the subsequent steam reforming process to heat the fuel to temperatures of between 400 and 600° C., preferably to 450° C. The process water is preferably heated by tubes located inside the steam-reforming reactor used in the pre-treatment step, to the same temperature range of 400 to 600° C. In the pre-treatment step the aromatic compounds in the fuel are hydrogenated and the fuel is gasified. Thus it is ensured that no more aromatic compounds are present in the fuel and no liquid fuel components reach the reformer where they would destroy the membrane and the catalyst.

A further advantage of the pre-treatment step is that the composition of the gas stream produced by this process is highly favourable for the steam reforming reaction as its methane content is very low. Within the alkane group, methane has the highest content of hydrogen atoms and its formation would thus require large quantities of hydrogen, which would have to be supplied by a recycle process.

The pre-treatment step is also insensitive to changes in throughput. All that is needed is a surplus of hydrogen in order to saturate the aromatic compounds and cracking products.

The aromatic compounds are therefore cracked and hydrogenated with hydrogen in the pre-treatment step. This is an exothermal process generating process heat, which can be used in the subsequent steam reforming process. The quantity of hydrogen necessary for the pre-treatment step can be taken from the steam reforming process. As the hydrogen partial pressure required for the diffusion process through the membrane is similar to the hydrogen partial pressure for the pre-treatment step, no further measures are necessary. Merely part of the pure hydrogen stream generated in the steam reforming process needs to be fed into the pre-treatment step. The partial pressure in the pre-treatment step is preferably between 10 and 80 bar. This simple principle makes it possible to use the pre-treatment step to remove aromatic compounds from the hydrocarbon stream, which are unwanted in the reformer as they cause coking and cannot be converted to hydrogen easily.

The pre-treatment step including the removal of aromatic compounds offers further advantages. The conversion leads to shorter carbon chains, which in turn facilitate the evaporation of the hydrocarbon stream. Moreover the hydrocarbons can be more easily mixed with the steam.

Thanks to the conversion of the aromatic compound contaminants, coking is prevented as aromatic compounds show a tendency to decomposition and coking. The reaction mostly yields carbon chains smaller 6 so that a back reaction to aromatic C₆-compounds can be ruled out.

The process, which features a combined cracking and hydrogenation process, is detailed in document DE 199 49 211.5 which is explicitly referred to here.

The hydrogen needed for the reaction can be taken from the steam reforming reaction. This is possible as the hydrogen has a high-purity of up to 100% and the hydrogen partial pressure needed for the reaction is also required for the diffusion process through the membrane. This not quite so easily possible with steam reforming processes which use hydrocarbons and air for generating process heat as the hydrogen is heavily diluted by nitrogen and the necessary hydrogen partial pressure cannot be achieved easily; sometimes this is only possible by raising the pressure in the whole system, which can involve considerable effort.

In the further course of the process the actual steam-reforming reaction takes place on the diffusion membrane, which preferably has a catalytic effect. However, a conventional catalyst can also be used in the steam-reformig process. Preferably the membrane is only hydrogen-permeable. The hydrocarbon stream reacts on the membrane and the generated hydrogen permeates through the membrane while the waste gas remains in the reactor. By separating the hydrogen, the chemical equillibrium of the reaction shifts in the direction of the products. The hydrogen produced is pure and free of catalyst poisons and residual hydrocarbons. Besides carbon monoxide, the residual gas also contains residual hydrogen, which cannot be separated by the membrane. This residual gas can be post-combusted or also fed into a fuel cell. The hydrogen stream generated can be further used in, e.g. a fuel cell. The electrical energy generated in the fuel cell can be used to heat the diffusion membrane in the membrane reactor.

The calculation of thermodynamic estimates for conventional systems compared with the process according to the invention shows that the electrical energy which is generated in a fuel cell and used to heat the diffusion membrane, is available due to the higher hydrogen yield of the overall system and that the overall efficiency rate of these reaction steps is no worse than that of conventional processes.

As regards the catalyst membrane it should be noted that it uses a precious-metal alloy, which has a sufficient hydrogen permeation rate at 800° C. and is also electroconductive. The membrane can be used a pure component or sandwiched onto a conducting material such as SiC. At the same time this membrane acts as a catalyst. This is of importance as the endothermal steam-reforming reaction occurs directly on the catalyst, which also serves as the heat source. This could purposefully prevent the catalyst from coking and also allow for the surface to be cleaned.

Thus the process according to the invention offers significant advantages compared to the state-of-the art processes. As high-purity hydrogen with a purity rate of up to 100% is generated in this process, the hydrogen does not subsequently need to be concentrated or compressed, e.g. by means of an additional, subsequent shift reaction in which the generated carbon monoxide is converted. By applying the required temperature gradient and removing the hydrogen, the reaction equillibrium is shifted in the direction of hydrogen, which means that hardly any byproducts are produced. The maximum possible quantity of hydrogen equals the stoichiometric reaction of hydrocarbons and water. The process itself takes place at a pressure of 10-80 bar, preferably 40 bar.

A further advantage of the process is that merely the reaction enthalpy for performing the reforming step needs to be supplied in the form of process heat. There is no nitrogen injection through a previous partial combustion of the hydrocarbon stream. The temperature or the temperature gradient can be precisely controlled through the line of resistance of the conductive materials, which makes it possible to control the permeability of the membrane and the velocity of the reaction. The reaction system can do completely without oxygen.

Another advantage is that the system's design is very compact and that the feed streams can be heated to the necessary temperature level by using either the reverse flow process or heat exchangers, which means that the heat quantities in the product gas stream can be fully utilised. Compared to other reactor systems, the mass stream in the membrane reactor process is very low indeed as the electric heating system ensures that no mass is required in the form of additional fuel.

Product feed is mainly achieved through liquid products (water and hydrocarbons), which can very easily be compressed to the necessary operational pressure using reciprocating pumps. The state-of-the-art processes using partial oxidation of air must compress the air with compressors and methane, if natural gas is used. The compression of gas requires significantly more energy than the compression of liquids so that standard processes cannot rely on cost-effective methods for pressure build-up. The process according the invention merely needs to compress the hydrogen recycle gas which accounts for 10-20% by volume of the hydrogen quantity, to operational pressure; this compression rate can be achieved by storing the hydrogen in a pressurised tank. This aspect of a cost-effective pressure build-up, which is necessary for a membrane process, constitutes another significant economic advantage compared to state-of-the-art technology.

A further advantage of the process according to the invention is the fact that it does not need the shift reaction at all and therefore avoids the energy losses normally incurred at this stage. The hydrogen is generated at a rate of up to 100% by volume. Thus the process according to the invention has a significantly higher efficiency rate than the state-of-the-art processes. Moreover the reaction temperature in synthesis gas generation can also be lower as heating takes place directly on the catalyst or the catalytically active membrane. Other reaction systems require a considerably higher temperature as the heat is not generated at the active centres directly.

The process according to the invention offers further advantages, e.g. with regard to processing the retentate (waste gas from the membrane reactor). Carbon dioxide can easily be liquefied as its critical temperature (31° C.) is relatively low (critical pressure 76 bar). Therefore it is possible to liquefy carbon dioxide at 0° C. and a pressure of 35 bar. The process for the generation of high-purity hydrogen operates with pressures of between 20 and 80 bar. Through separating the hydrogen inside the membrane reactor and through the condensation of the water, a carbon dioxide-rich gas with a CO₂-content of at least 70% remains. Apart from its main component, this gas also contains hydrogen and non-converted hydrocarbons as well as carbon monoxide. The processes described according to the state of the art subject this gas to post-combustion. The maximum temperature that can be achieved with this gas is low because of the large quantities of non-combustible gases. For this reason this gas is not suitable to reach the high temperature levels needed for the reformer. Some of the processes described according to the state of the art use partial oxidation to reach the necessary reformer temperature. For this purpose air is added to the substance to be reformed. As air contains a considerable content of nitrogen, the carbon dioxide is diluted.

The process described here does not have this disadvantage. As no air is used, the carbon dioxide gas generated is only contaminated by non-separated hydrogen and non-converted hydrocarbons as well as carbon monoxide. This highly concentrated carbon dioxide can be liquefied and separated from the combustible gases at moderate temperatures. Dilution using nitrogen would lower the partial pressure of the carbon dioxide in the gas so much that liquefidation would only be achieved at a very high system pressure or, alternatively, at a very low liquefidation temperature.

The liquid carbon dioxide can be used for cooling purposes. Should a recycling possibility be created for the carbon dioxide, the system can store the carbon dioxide and release it for further processing when being refuelled with hydrocarbons.

Due to the possibility of separating the retentate into combustible and non-combustible compounds, the system can be operated with lower conversion rates (relative to the hydrogen yield). Following the separating of the retentate, the combustible gases are available as heating gas in an undiluted state. As it is known that chemical processes only achieve a 100% conversion rate at considerable expense, technology in many cases resorts to cleaning and recycling non-converted products. The advantage being that the necessary heat for the endothermal steam-reforming reaction can be generated from the cleaned retentate and thus a considerable amount of reaction time can be saved or a lower reaction temperature can be chosen. The conversion rate is reduced to that quantity which generates the required quantity of heating gas. The process differs from the state of the art in so far as it yields two products from the fuel: Hydrogen (for the fuel cell) and heating gas (for the steam reformer). The heating gas can generate the required heat by direct combustion using atmospheric oxygen as well as by using the fuel cell in connection with an electric heating system. One of the fuel cells suitable for this purpose is the SOFC which can be operated with residual hydrocarbons and which tolerates the contained carbon monoxide.

In principle it is, however, also be possible to separate only that amount of hydrogen through the membrane in the membrane reactor which is necessary for the pre-treatment step and to operate an SOFC with the remaining retentate.

As described below, the system-related hydrogen pressure makes it possible to do without an additional energy source in the form of a starter battery. The hydrogen is available at high pressure, which allows tank storage of sufficient hydrogen quantities to start system operation. The hydrogen tank also allows the system to compensate short-term peak demand. Such peak demand is caused when vehicles accelerate or when electric cookers are used in the household. Pressurised operation makes it possible to compensate such peaks and to operate the reformer continuously. Compared to state-of-the-art technology, the necessary response times can be significantly slower. This simplifies process control considerably. A further advantage is the fact that the residual hydrogen, which is still being generated during reformer shutdown operation, is not lost as the hydrogen is stored by the compressor in a tank.

Incompletely converted hydrogen from other systems can also be used within this system. Thus the fuel cell makes a low-pressure hydrogen stream available, which would have to be burned in conventional systems.

As the system generates hydrogen pressure it is possible to store hydrogen in a pressurised tank. The fuel cell and other consumers can take hydrogen from this pressurised tank. The system can therefore be put into operation without any external energy source such as starter battery. The possibility to store hydrogen (due to the pressure) makes it possible to buffer lower consumption levels and/or store the hydrogen, which is not immediately consumed. Thus the system can be uncoupled from its consumers. This results in a simpler and cheaper control system. The simpler control system is especially effective during start-up and shutdown operations when the hydrogen buffer can be used. Thanks to the buffer it also possible to implement changes in the quantity of hydrogen generated considerably faster as increased demand would first be satisfied from the buffer and then hydrogen production would be increased in line with optimal energy efficiency considerations. When the production rate is being reduced, any surplus of hydrogen generated is stored in the tank and is readily available. As state-of-the-art systems work at normal pressure, they do not offer this possibility and would require additional equipment to create such a hydrogen buffer.

Moreover the invention relates to a hydrocarbon mixture suitable for the process according to the invention. The mixture's composition can be determined as follows:

The hydrocarbon mixtures are analysed according to, e.g. PIONA. This method allows the determination of the different structural elements. The structural elements' energetic contribution can be determined from the pure components by means of thermodynamic calculations. Therefore it is possible to allocate an energy contribution to each material stream. By way of a balancing calculation the mixing ratio can now be determined (see the toluol/dodecane example in table 2). Table 1 shows that aromatic compounds have a negative enthalpy, i.e. a surplus of heat is generated, while paraffins have a positive enthalpy, i.e. heat is required to reach the target temperature. In the ideal case the mixture would show a zero enthalpy for preselected pressure and temperature values (see examples 1 and 2 in table 2). If steam is additionally heated in a special embodiment of the invention, the enthalpy must have the same value that the steam requires to reach the target temperature. Preferably the enthalpy value is great enough to additionally compensate heat losses in the system.

The structural parameters are determined as described below:

The product composition in the production of n-paraffins is known for certain temperatures and pressures. In these conditions the enthalpy of the reaction can be determined by means of thermodynamic calculations (hydrocarbons plus hydrogen at ambient temperature to the target products at target temperature). These calculations are performed for different pure components (see table). The result is a set of enthalpy values. The number of pure components featuring different structural elements examined must be at least equal to the number of structural elements present, so that an overdetermined equation system is created. The solution of this equation system shows the energy value for each individual structural parameter. The thermodynamic parameters are usually not known for real mixtures, so that the enthalpy values need to be determined experimentally. The result of the calculation on the one hand depends heavily on the final temperature and, on the other hand, on the quality of the catalyst or, as the case may be, of the resulting composition of the reactant gases following the pre-treatment step.

Table 3 shows that the mean reactor temperature corresponds to the thermodynamic calculations. In all cases the reactor outlet temperature was approximately 400° C. The mean temperature does not change with the catalyst's load. In all cases the existing reactor heating system was lower than the temperature inside the reactor. The heating system merely served to compensate the system's heat losses.

The gasification activity, which can be seen from the composition of the reactant gas, is also constant. In the experiment featuring WHSV=1, the higher butane concentration at the expense of the propane concentration was caused by the slightly lower outlet temperature. With regard to the reformer's operation it does not matter whether more propane or more butane is available. The propane-butane ratio depends heavily on the outlet temperature while the respective contribution to the reaction enthalpies is rather similar for both propane and butane. This ratio adjusts itself as a function of the final temperature. These experiments were conducted without any external control and only the heat losses were compensated for, so that the fluctuation of the propane-butane ratio can be attributed to the fact that stationary state was not reached.

Table 4 shows that power input of the stage is constant over the load value or, as the case may be, slightly exothermal. A comparison of the power input in both the non-operating and the operating conditions shows that approximately 30% of the losses are compensated for by the reaction heat.

Further advantages of the invention are:

The reactor used for the pre-treatment step in which the n-paraffins are produced, can be operated without a heating system and without a sophisticated control unit. This is an important advantage, especially with regard to mobile operation. In terms of the structure of apparatus, the system thus becomes much simpler. A safety-related aspect of equal importance is the fact that such a mixture cannot lead to the catalyst overheating or even being destroyed as the reaction's adiabatic final temperature can be precisely adjusted through the composition of the hydrocarbon mixture.

Short description of how to determine the necessary content of hydrogenatable aromatic compounds using table 1 below:

The components intended to be used in the hydrocarbon mixture are analysed by means, for example, of PIONA or NMR. The resulting classes of paraffinic, olefinic and aromatic components are converted into their respective structural molar content. An enthalpy value is assigned to these structural groups (paraffinic CH3—, CH2—, CH and aromatic CH—, C—), which is either derived from the pure components or determined by means of an appropriate experiment. Using this data it is possible by means of the rule of alligation to add the exact quantity of aromatic components to the hydrocarbon mixture as is necessary to reach a certain temperature level. The hydrogen quantity required for hydrogenation and separation can be determined from the difference of the elementary analyses between source substance and target product.

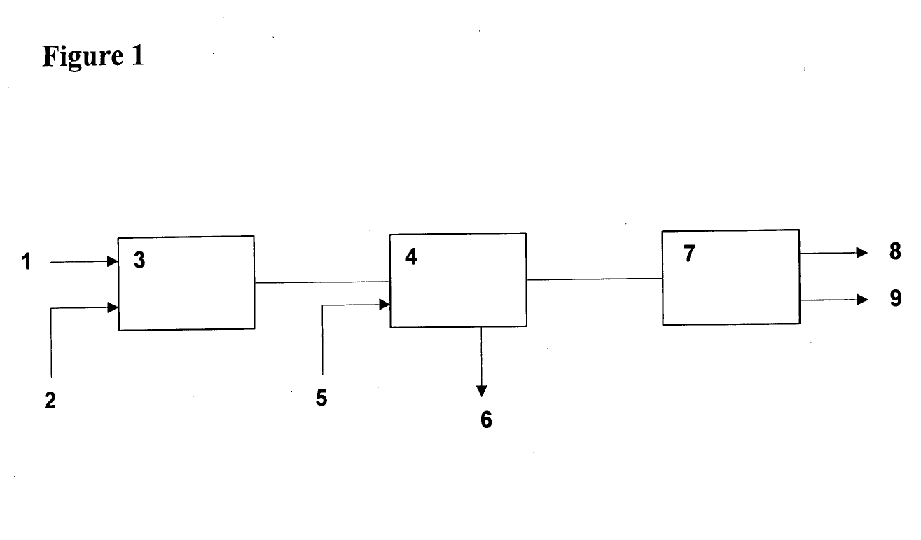

FIGS. 1 and 2 serve to explain the invention in greater detail.

FIG. 1 shows a flow chart of the process according to the invention featuring a preferred embodiment including a pre-treatment step and a subsequent fuel cell. The hydrocarbon stream, e.g. in the form of fuel, is initially fed to the pre-treatment step. The fuel stream is hydrogenated in this pre-treatment step in order to remove the aromatic compounds and the cleaned hydrocarbon stream is subsequently fed into the reformer. Its conversion to hydrogen gas takes place in the reformer. Part of the hydrogen gas is fed back to the pre-treatment step, another part of the hydrogen gas is fed into a fuel cell and used to generate electrical energy which in turn is used to heat the membrane at the reformer stage. The remaining hydrogen gas can be used for any desired purpose, e.g. in a fuel cell to generate electrical energy or in any other way. The residual gas generated in the reformer is subjected to post-combustion in the steam-reforming reactor. In this way the hydrogen is not lost in the pre-treatment step.

FIG. 2 displays different designs of the membrane reactor according to the invention. The reactor preferably consists of a tube whose outer wall preferably has a multi-layered structure. This structure is as follows, from the inside to the outside. The reactor receives a membrane (1) made of precious metal. This membrane consists of precious metal and is preferably catalytically active. It is in this layer that the actual reaction of the hydrocarbon gas takes place. For stabilisation purposes a net (2) of porous material, which can be heated via an electric heating conductor, can preferably be laid around this layer. In this way it is possible to heat the membrane. The hydrogen gas generated leaves the reactor by permeating through the membrane. Further preferred embodiments of the membrane reactor are shown in FIGS. 2b and 2c. In version 2b an electric heating conductor is located in the centre of the membrane reactor, which can additionally be used for heating purposes or alternatively be used together with electric heating conductors outside the reactor.

FIG. 2c shows another preferred embodiment featuring a hollow body as the electric heating conductor, in whose hollow body additional post-combustion of waste gas together with air can take place.

Key to FIG. 1

1 Hydrocarbons and derivatives

2 Hydrogen

3 Chemical evaporator

4 Membrane reactor

5 Water

6 Hydrogen

7 Retentate separation

8 Heating gas

9 Carbon dioxide and water

Key to FIG. 2

1 Catalyst membrane, e.g. Pd/Ag

2 Net, porous metal or ceramics

3 Heating conductor

4 Air/retentate stream

1. Membrane reactor for the generation of high-purity hydrogen from a hydrocarbon stream and steam comprising a hydrogen-permeable diffusion membrane to separate the hydrogen gas from the residual gas; with the reactor being fitted with heating elements characterised in that one of the heating elements is a heating conductor located in the centre of the reactor.

2. Membrane reactor according to claim 1, characterised in that the reactor contains a catalyst for converting hydrocarbons into hydrogen and that this catalyst is preferably located inside or directly on the diffusion membrane.

3. Membrane reactor according to claims 1 or 2, characterised in that the membrane material itself has a catalytic effect

4. Membrane reactor according to claims 1 through 3, characterised in that the membrane is fitted with heating elements.

5. Membrane reactor according to claims 1 through 4, characterised in that the heating element is either an electric and/or a combustion heating system with the fuel being hydrogen, carbon monoxide and/or hydrocarbons.

6. Membrane reactor according to claims 1 through 5, characterised in that the heating conductor is of tubular shape which allows the post-combustion of the residual gas.

7. Membrane reactor according to claims 1 through 6, characterised in that the catalyst is a hydrogen-permeable membrane containing a Pd/Ag alloy.

8. Membrane reactor according to claims 1 through 7, characterised in that the membrane is either electroconductive or covered with an electroconductive coating.

9. Membrane reactor according to claims 1 through 8, characterised in that the diffusion membrane is concentrically and coaxially arranged around the reaction space and forms the reactor wall.

10. Process for the generation of high-purity hydrogen gas from a hydrocarbon stream and steam, comprising the following steps:
1. Performing a steam-reforming reaction,
2. Separating the generated hydrogen by means of a diffusion membrane,
3. Performing a pre-treatment step in order to hydrogenate the hydrocarbon stream consisting of a hydrocarbon mixture, while at the same time generating n-paraffins, with the hydrocarbon mixture preferably containing such a level of hydrogenatable hydrocarbons that the heat of hydrogenation generated in the pre-treatment step is sufficient to enable the pre-treatment step to proceed and to make the hydrocarbon stream leaving the pre-treatment step reach the desired target temperature.

11. Process according to claim 10, characterised in that the steam-reforming reaction and the separation of the hydrogen are carried out in a membrane reactor.

12. Process according to claim 11, comprising the following steps:
a) Heating the diffusion membrane of the reactor to temperatures of between 500 and 1000° C.
b) Feeding the reactant stream into the reactor and converting it on the diffusion membrane, which is preferably fitted with a catalyst, at temperatures of between 500 and 1000° C.
c) Removing the generated hydrogen from the reactor through the diffusion membrane.
d) Removing the residual gas stream through the reactor

13. Process according to claims 10 through 12, characterised in that the n-paraffins generated in the pre-treatment step are mainly methane, ethane, propane and butane

14. Process according to claims 10 through 13, characterised in that the process water required for the steam-reforming process is vaporized in the pre-treatment step.

15. Process according to claims 10 through 14, characterised in that the generated heat of hydrogenation is sufficient to heat the process steam for the steam-reforming step up to the entrance temperature for the membrane reactor.

16. Process according to claims 10 through 15, characterised in that the process water is heated to temperatures of between 400 and 600° C. in tubes located inside the reactor needed for the pre-treatment step.

17. Process according to claims 10 through 16, characterised in that the aromatic compounds contained in the fuel are hydrogenated and the fuel is fully gasified in the pre-treatment step.

18. Process according to claims 10 through 17, characterised in that a surplus of hydrogen is used in the pre-treatment step to ensure sufficient saturation of the aromatic compounds and cracking products.

19. Process according to claims 10 through 18, characterised in that the diffusion membrane is only hydrogen-permeable.

20. Process according to claims 10 through 19, characterised in that the residual gas stream in the steam-reforming reactor is subjected to post-combustion.

21. Process according to claims 10 through 20, characterised in that the carbon dioxide contained in the retentate is removed especially by means of liquidisation and the remaining residual gas stream is preferably subjected to post-combustion.

22. Process according to claims 10 through 21, characterised in that the generated hydrogen is stored in a tank during reformer shutdown operations and preferably fed back to the reactor/fuel cell during start-up operations or at times of peak demand.

23. Hydrocarbon mixture suitable for performing a pre-treatment step according to claims 10, 14 or 15.
